(19) United States
(12) Patent Application Publication
(10) Pub. No.: US 2026/0254072 A1
(43) Pub. Date: Aug. 27, 2026

(54) BATTERY MODULE AND BATTERY PACK

(71) Applicant: HONDA MOTOR CO., LTD., Tokyo (JP)

(72) Inventor: Takeshi YOKOMIZO, Saitama (JP)

(73) Assignee: HONDA MOTOR CO., LTD., Tokyo (JP)

(21) Appl. No.: 19/545,036

(22) Filed: Feb. 20, 2026

(30) Foreign Application Priority Data
Feb. 26, 2025 (JP) 2025-029048

(51) Int. Cl. H01M 50/588; H01M 50/105; H01M 50/119; H01M 50/178; H01M 50/211; H01M 50/59

(52) U.S. Cl. CPC H01M 50/588; H01M 50/105; H01M 50/119; H01M 50/178; H01M 50/211; H01M 50/59; H01M 2220/20

(57) ABSTRACT

A battery module has a plurality of laminated battery cells, and a plate-shaped member having an upper surface on which the battery cells are placed. Each of the battery cells includes a terminal, and a terminal adjacent portion that is adjacent to the terminal and is a portion between the terminal and a lower end of the battery cell. The terminal adjacent portion is a portion where a metal portion in the battery cell is exposed. A groove extending in a lamination direction of the battery cells is provided on the upper surface of the plate-shaped member at a position where the groove overlaps the terminal adjacent portion of the battery cell as viewed from an upper-lower direction.

### CROSS-REFERENCE TO RELATED APPLICATIONS

This application is based on and claims priority under 35 USC 119 from Japanese Patent Application No. 2025-029048 filed on Feb. 26, 2025, the entire content of which is incorporated herein by reference.

### TECHNICAL FIELD

The present disclosure relates to a battery module and a battery pack mounted on a moving object such as a vehicle.

### BACKGROUND ART

In recent years, researches and developments have been conducted on a secondary battery which contributes to improvement in energy efficiency in order to allow more people to have access to affordable, reliable, sustainable and advanced energy.

Since a temperature of the battery increases due to heat generation by charging and discharging, and the temperature drops when charging and discharging are stopped, moisture in air condenses with the temperature drop, and condensation water may adhere to a surface of the battery. When the battery is left in a low-temperature environment, condensation water may adhere to the surface of the battery. Occurrence of such condensation water may cause a short circuit or a ground fault, and measures are required.

For example, in a battery module described in JP2012-256465A, a load transmission portion is interposed between bottom surfaces of a plurality of battery cells and an elastic member, and the load transmission portion has a labyrinth structure. Accordingly, even when the two battery cells are short-circuited via the condensation water and the elastic member, conduction of the condensation water is interrupted by the labyrinth structure.

In a battery cooling device described in JP5624015B, a non-conductive insulating sheet formed in a dish shape is disposed between a cooling surface of a battery module and a cooling plate, and the insulating sheet can block condensation water from flowing to a cooling plate side.

For example, in the structure in JP5624015B, occurrence of a ground fault is prevented by providing the insulating sheet, but there is room for improvement because the number of components increases.

### SUMMARY OF INVENTION

The present disclosure provides a battery module and a battery pack capable of preventing a ground fault between a battery cell and a plate-shaped member due to condensation water while reducing an increase in the number of components.

A first aspect of the present disclosure is a battery module having:

a plurality of laminated battery cells; and

a plate-shaped member having an upper surface on which the battery cells are placed, in which

each of the battery cells includes a terminal, and a terminal adjacent portion that is adjacent to the terminal and is a portion between the terminal and a lower end of the battery cell,

the terminal adjacent portion is a portion where a metal portion in the battery cell is exposed, and

a groove extending in a lamination direction of the battery cells is provided on the upper surface of the plate-shaped member at a position where the groove overlaps the terminal adjacent portion of the battery cell as viewed from an upper-lower direction.

A second aspect of the present disclosure is a battery pack having:

a plurality of laminated battery cells; and

a battery case in which the battery cells are placed on an upper surface of a bottom plate and that accommodates the battery cells, in which

each of the battery cells includes a terminal and a terminal adjacent portion that is adjacent to the terminal and is a portion between the terminal and a lower end of the battery cell,

the terminal adjacent portion is a portion where a metal portion in the battery cell is exposed, and

a groove extending in a lamination direction of the battery cells is provided on the upper surface of the bottom plate of the battery case at a position where the groove overlaps the terminal adjacent portion of the battery cell as viewed from an upper-lower direction.

According to the aspects of the present disclosure, it is possible to prevent the ground fault between the battery cell and the plate-shaped member due to condensation water while reducing the increase in the number of components.

### BRIEF DESCRIPTION OF DRAWINGS

Exemplary embodiment(s) of the present invention will be described in detail based on the following figures, wherein:

FIG. 1 is an exploded perspective view of a battery pack according to an embodiment of the present disclosure;

FIG. 2 is an exploded perspective view of a battery module according to the embodiment of the present disclosure;

FIG. 3 is a schematic cross-sectional view illustrating an internal structure of a battery cell;

FIG. 4 is a side view of the battery cell placed on a lower plate;

FIG. 5 is an enlarged side view of a groove provided in the lower plate;

FIG. 6 is top views illustrating various forms of the groove provided in the lower plate; and

FIG. 7 is a side view of the battery cell placed on a bottom plate of a battery case.

### DESCRIPTION OF EMBODIMENTS

Hereinafter, an embodiment of a battery module and a battery pack according to the present disclosure will be described with reference to the accompanying drawings. The battery module and the battery pack are mounted on a moving object such as a vehicle, and in the drawings, a front of the moving object is denoted by Fr, a rear is denoted by Rr, a left is denoted by L, a right is denoted by R, an upper side is denoted by U, and a lower side is denoted by D.

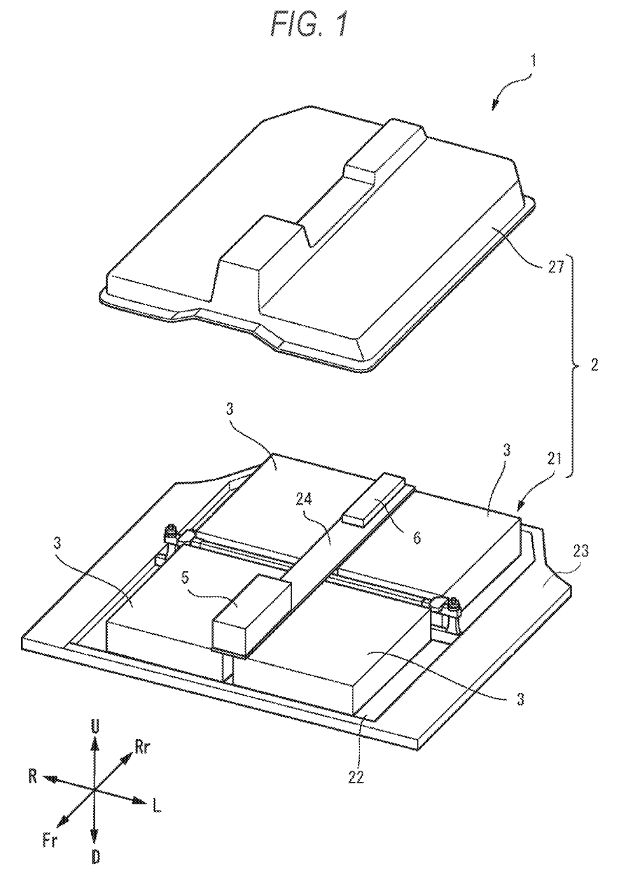

FIG. 1 is a top view of a battery pack 1 according to the embodiment of the present disclosure. The battery pack 1 is mounted on an electric vehicle such as an electric automobile, a hybrid vehicle (including a plug-in hybrid vehicle), or a fuel cell vehicle. The battery pack 1 is attached under a floor of the electric vehicle. The battery pack 1 stores and discharges electric power to be supplied to a motor or the like serving as a drive source of the electric vehicle.

The battery pack 1 includes a battery case 2 and a plurality of battery modules 3 accommodated in the battery case 2. Here, four battery modules 3 are accommodated in the battery case 2.

The battery case 2 includes a case body 21 on which the battery module 3 is placed, and a case cover 27 that covers the case body 21 from above. The case body 21 includes a bottom plate 22 having an upper surface on which the battery module 3 is placed, and a frame member 23 joined to the bottom plate 22 and constituting an outer frame of the case body 21. The case body 21 has a tray shape capable of accommodating the battery module 3. The frame member 23 is, for example, an aluminum casting. The frame member 23 is joined to an outer edge portion of the bottom plate 22 and constitutes front, rear, left, and right side walls of the battery case 2.

The case body 21 is provided with a bracket 24 provided above the battery module 3 and extending in a front-rear direction. The bracket 24 is provided at a central portion in a left-right direction. A junction box 5 is mounted on a front side portion of the bracket 24, and a battery Electronic Control Unit (ECU) 6 is mounted on a rear side portion of the bracket 24.

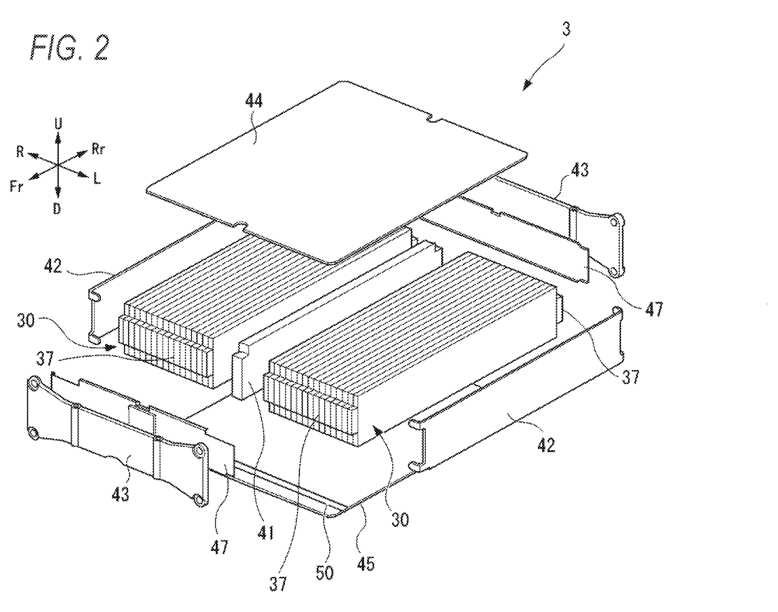

As illustrated in FIG. 2, each battery module 3 includes a plurality of battery cells 30, an intermediate plate 41, a pair of end plates 42, a pair of cover plates 43, an upper plate 44, and a lower plate 45. The intermediate plate 41, the end plate 42, the cover plate 43, the upper plate 44, and the lower plate 45 are, for example, plate-shaped members formed of a metal material.

Each of the battery cells 30 is, for example, a lithium ion battery or a nickel hydrogen battery. The battery cell 30 may have a liquid electrolyte or a solid electrolyte (that is, a solid-state battery). In the present embodiment, a case where the battery cell 30 is a solid-state battery will be described as an example.

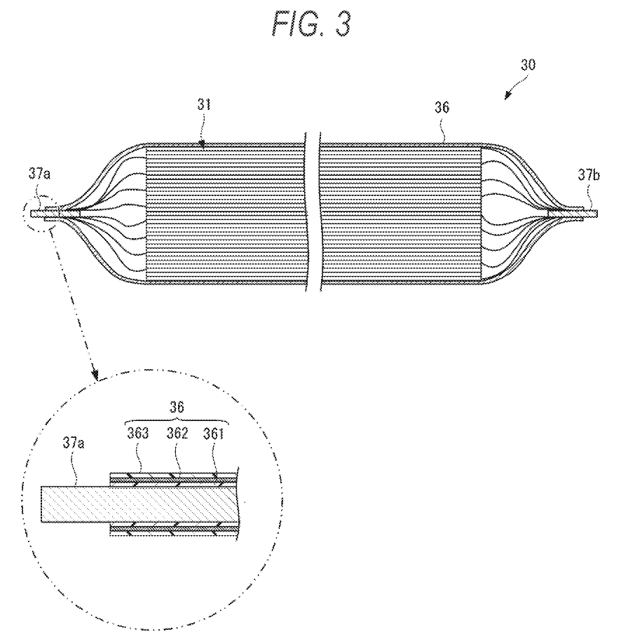

As illustrated in FIG. 3, the battery cell 30 includes an electrode laminate 31 in which a plurality of positive electrode layers and a plurality of negative electrode layers are laminated via solid electrolyte layers, a sheath 36 that accommodates the electrode laminate 31, and a positive electrode terminal 37a and a negative electrode terminal 37b that protrude from the sheath 36. The positive electrode terminal 37a and the negative electrode terminal 37b are also collectively referred to as a terminal 37.

The positive electrode layer includes a positive electrode current collector and a positive electrode active material layer laminated on each other. The positive electrode current collector has a function of collecting current from the positive electrode active material layer. The positive electrode current collector preferably includes at least one material having high conductivity. Examples of a highly conductive material include aluminum, an aluminum alloy, stainless steel, nickel, iron, and titanium.

The positive electrode active material layer contains, for example, a positive electrode active material and a solid electrolyte. The positive electrode active material layer is formed by applying a positive electrode slurry, which is generated by kneading the positive electrode active material and the solid electrolyte together with a dispersion medium (a mixed solution of a conductive additive, a binder, and a solvent), to the positive electrode current collector, and drying the positive electrode slurry.

The negative electrode layer includes a negative electrode current collector and a negative electrode active material layer laminated on each other. The negative electrode current collector has a function of collecting current from the negative electrode active material layer. The negative electrode current collector preferably includes at least one material having high conductivity. Examples of a highly conductive material include copper, nickel, and stainless steel.

The negative electrode active material layer is formed by applying a negative electrode slurry, which is generated by kneading a negative electrode active material and the solid electrolyte together with a dispersion medium, to the negative electrode current collector, and drying the negative electrode slurry.

The solid electrolyte layer is formed between the positive electrode layer and the negative electrode layer. A material constituting the solid electrolyte layer can be similar as that used for a solid electrolyte of a general solid-state battery, and examples thereof include solid electrolytes such as a sulfide-based solid electrolyte material and an oxide solid electrolyte.

The sheath 36 is, for example, a lamination film, and seals the entire electrode laminate 31. The sheath 36 is implemented as a laminated film having a three-layer structure in which an inner resin portion 361, a metal portion 362, and an outer resin portion 363 are laminated in this order from the inside. As a material for the inner resin portion 361 and the outer resin portion 363, for example, a thermoplastic resin such as polyethylene terephthalate (PET), polyamide (nylon), or polypropylene (PP) can be used. For example, aluminum can be used as the material for the metal portion 362.

The positive electrode terminal 37a is formed of a similar material as the positive electrode current collector. The positive electrode current collector extending from the electrode laminate 31 is joined and electrically connected to the positive electrode terminal 37a. The negative electrode terminal 37b is formed of a similar material as the negative electrode current collector. The negative electrode current collector extending from the electrode laminate 31 is joined and electrically connected to the negative electrode terminal 37b. In the present embodiment, the positive electrode terminal 37a is provided on one end side in a longitudinal direction of the battery cell 30, and the negative electrode terminal 37b is provided on the other end side. The positive electrode terminal 37a and the negative electrode terminal 37b may be provided on the same side of the battery cell 30.

As illustrated in FIG. 2, the plurality of battery cells 30 each have an elongated shape and are laminated in a horizontal direction. In the present embodiment, a lamination direction of the battery cells 30 is a left-right direction, and the longitudinal direction is a front-rear direction. The terminal 37 (the positive electrode terminal 37a and the negative electrode terminal 37b) protrude to a front end side and a rear end side of the battery cell 30, and are electrically connected to each other via a plurality of bus bars (not illustrated).

The intermediate plate 41 is provided at an intermediate portion in the lamination direction of the plurality of battery cells 30. One intermediate plate 41 is provided at a center position in the lamination direction of the battery cells 30, but two or more intermediate plates 41 may be provided.

The pair of end plates 42 are provided on two ends of the plurality of battery cells 30 in the lamination direction, respectively. The pair of end plates 42 receive a swelling force in the lamination direction due to swelling of the battery cells 30 due to aging or the like.

The pair of cover plates 43 are provided at two ends of the plurality of battery cells 30 in the longitudinal direction, respectively. Both left and right ends of the cover plate 43 are connected to the pair of end plates 42 via fastening members. The cover plate 43 covers and protects the terminal 37 of the battery cells 30 and the bus bars from the front-rear direction via a non-conductive bus bar cover 47.

The upper plate 44 and the lower plate 45 face each other in an upper-lower direction and cover the plurality of battery cells 30, the intermediate plate 41, and the pair of end plates 42 from the upper-lower direction. The upper plate 44 and the lower plate 45 constitute an upper surface and a bottom surface of the battery module 3.

The upper plate 44 and the lower plate 45 are connected to the pair of end plates 42 by welding, for example, and restrain the plurality of laminated battery cells 30. The upper plate 44 and the lower plate 45 restrain the plurality of battery cells 30, but do not prohibit dimensional expansion of the battery cells 30 in the lamination direction due to the cell swelling. The upper plate 44 and the lower plate 45 can extend in the lamination direction so as to allow dimensional expansion in the lamination direction to some extent.

The upper plate 44 and the lower plate 45 have high thermal conductivity, and have a function of promoting heat dissipation of the battery cell 30 by coming into contact with the battery cell 30.

As illustrated in FIGS. 2, 4 and 5, a groove 50 extending in the lamination direction of the battery cells 30 is provided on an upper surface of the lower plate 45 at a position where the groove 50 overlaps a terminal adjacent portion 36a (described later) of the battery cell 30 as viewed from the upper-lower direction. The groove 50 is a portion where a thickness of the lower plate 45 is smaller than that of the other portion, and is formed in the lower plate 45 by, for example, cutting out. The groove 50 may be formed by bending and recessing the lower plate 45, for example.

A cross-sectional shape of the groove 50 is, for example, rectangular, but may be, for example, semicircular or V-shaped.

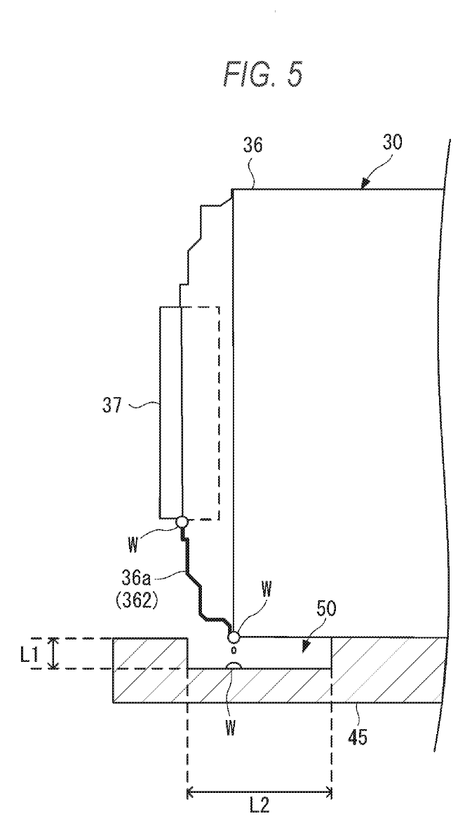

The terminal adjacent portion 36a of the battery cell 30 is a part of a peripheral edge portion of the sheath 36 and corresponds to two end portions of the battery cell 30 in the longitudinal direction. In the present embodiment, in particular, the terminal adjacent portion 36a refers to a portion adjacent to the terminal 37 and between the terminal 37 and a lower end of the battery cell 30 as indicated by a thick solid line in FIG. 5. The sheath 36 includes the metal portion 362 (see FIG. 3), and the metal portion 362 is exposed at the terminal adjacent portion 36a. This is caused by a step of cutting the sheath 36 (lamination film) at the time of producing the battery cell 30.

Since a temperature of the battery cell 30 increases due to heat generation by charging and discharging, and the temperature drops when charging and discharging are stopped, moisture in air condenses with the temperature drop, and condensation water may adhere to a surface of the battery cell 30. When the battery cell 30 is left in a low-temperature environment, condensation water may adhere to the surface of the battery cell 30. When such condensation occurs, as illustrated in FIG. 5, condensation water W may adhere to a vicinity of the terminal 37 of the battery cell 30. If the groove 50 is not provided, when the condensation water W adheres between the terminal 37 and the terminal adjacent portion 36a and to a lower end of the terminal adjacent portion 36a, the terminal 37 may be electrically connected to the lower plate 45 via the condensation water W to cause a ground fault, or the battery cells 30 may be short-circuited via the condensation water W and the lower plate 45.

In the present embodiment, since the groove 50 is provided on the upper surface of the lower plate 45 at a position where the groove 50 overlaps the terminal adjacent portion 36a of the battery cell 30 as viewed from the upper-lower direction, a gap is formed between the terminal adjacent portion 36a and the lower plate 45, and the terminal 37 is prevented from being electrically connected to the lower plate 45 via the condensation water W. Therefore, the ground fault and the short circuit as described above can be prevented, and safety is ensured. It is not necessary to separately provide an insulating sheet or the like in order to prevent a ground fault or a short circuit, and the number of components can be reduced.

A depth dimension L1 of the groove 50 is preferably 3 mm or more, for example. Accordingly, even when the condensation water W is accumulated in the groove 50, it is possible to avoid contact between the condensation water W and the terminal adjacent portion 36a.

A width dimension L2 of the groove 50 in a direction orthogonal to the lamination direction is preferably twice or more the depth dimension L1. By increasing the width dimension L2 of the groove 50, it is possible to prevent the condensation water from overflowing even if the condensation water is accumulated in the groove 50.

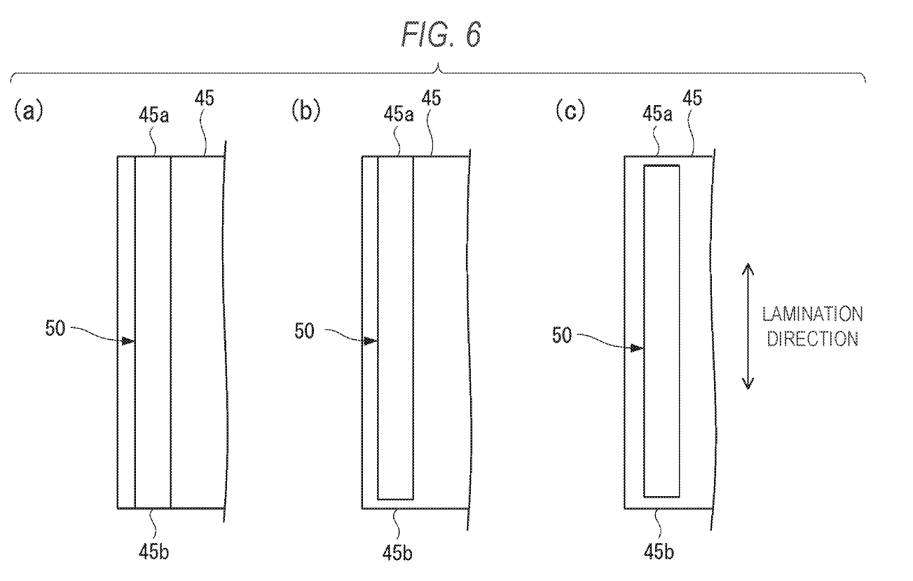

A length of the groove 50 in the lamination direction (left-right direction) of the battery cells 30 can vary. For example, in one example illustrated at section (a) of FIG. 6, the groove 50 is equal to a length of the lower plate 45 in the lamination direction, that is, extends to two ends 45a and 45b of the lower plate 45 in the lamination direction. According to such a configuration, the condensation water W accumulated in the groove 50 can be discharged from two end sides of the groove 50.

In another example illustrated at section (b) of FIG. 6, the groove 50 is shorter than the length of the lower plate 45 in the lamination direction, one end side in the lamination direction extends to the one end 45a of the lower plate 45, and the other end side extends to just before the other end 45b of the lower plate 45. The condensation water W accumulated in the groove 50 is discharged from the one end side of the groove 50. Since the other end side of the groove 50 does not extend to the other end 45b of the lower plate 45, the condensation water W is not discharged from the other end side, and rigidity of the lower plate 45 can be ensured.

In another example illustrated at section (c) of FIG. 6, the groove 50 is shorter than the length of the lower plate 45 in the lamination direction, and two sides of the groove 50 in the lamination direction extend to just before the two ends 45a and 45b of the lower plate 45 in the lamination direction. According to such a configuration, the rigidity of the lower plate 45 can be sufficiently ensured while the groove 50 is provided in the lower plate 45. In this case, since the condensation water W is not discharged from the two end sides of the groove 50, the condensation water W accumulates in the groove 50 until the condensation water W evaporates, but since the groove 50 has a sufficient volume as described above, the condensation water W does not overflow from the groove 50.

Three examples of the length of the groove 50 in the lamination direction are illustrated, but in any case, the groove 50 preferably has a length that overlaps with all the battery cells 30 as viewed from the upper-lower direction.

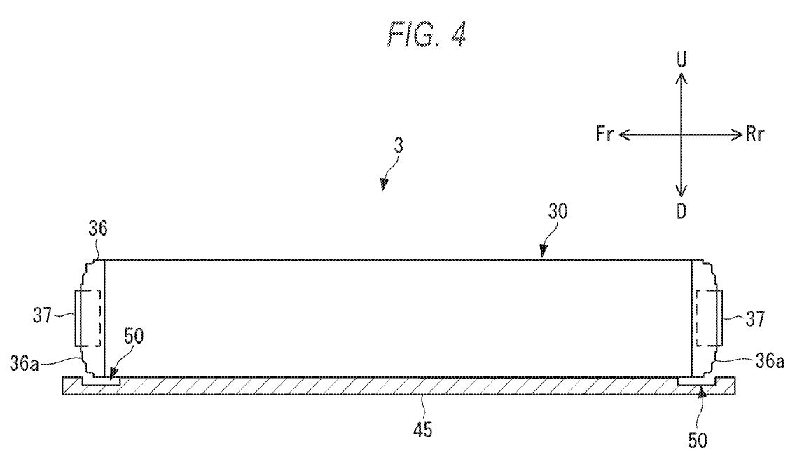

Returning to FIG. 4, the upper surface of the lower plate 45 is formed flat except for the groove 50, and is in contact with a lower surface of the battery cell 30. In other words, the battery cell 30 is in contact with the upper surface of the lower plate 45 at a portion other than the groove 50. Accordingly, when a temperature of the battery cell 30 increases, heat dissipation of the battery cell 30 from the lower plate 45 can be promoted.

### Modification

In the above-described embodiment, the battery pack 1 in which the battery cells 30 are modularized and accommodated in the battery case 2 has been described, but the battery pack 1 may have a configuration in which the battery cells 30 are directly accommodated in the battery case 2 without being modularized (Cell to Pack).

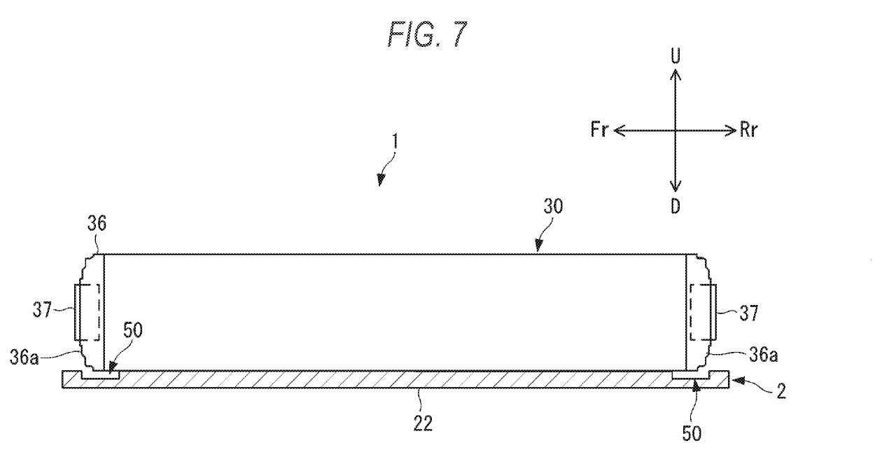

FIG. 7 is a schematic side view illustrating a state where the battery cell 30 is directly placed on the bottom plate 22 of the battery case 2. The groove 50 extending in the lamination direction of the battery cells 30 is provided on an upper surface of the battery case 2 at a position where the groove 50 overlaps the terminal adjacent portion 36a of the battery cells 30 as viewed from the upper-lower direction. With such a configuration, a gap is formed between the terminal adjacent portion 36a and the bottom plate 22, and the terminal 37 is prevented from being electrically connected to the bottom plate 22 via the condensation water W. Therefore, a ground fault between the battery cell 30 and the bottom plate 22 can be prevented, and safety is ensured.

Although an embodiment and modifications of the present disclosure have been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, components in the above embodiment may be freely combined without departing from the gist of the invention.

For example, in the above-described embodiment, the battery cell 30 is a cell of a lamination type, but a shape of the cell is not limited thereto, and may be, for example, a square cell. In this case as well, similarly, the groove 50 may be provided at a position where the groove 50 overlaps a terminal adjacent portion of the square cell as viewed from the upper-lower direction to extend in a lamination direction of the square cells.

In this specification, at least the following matters are described. In the parentheses, the corresponding constituent elements and the like in the above embodiment are illustrated as an example, but the present invention is not limited thereto.

(1) A battery module (battery module 3) including:

a plurality of laminated battery cells (battery cells 30); and

a plate-shaped member (lower plate 45) having an upper surface on which the battery cells are placed, in which

each of the battery cells includes a terminal (terminal 37), and a terminal adjacent portion (terminal adjacent portion 36a) that is adjacent to the terminal and is a portion between the terminal and a lower end of the battery cell,

the terminal adjacent portion is a portion where a metal portion (metal portion 362) in the battery cell is exposed, and

a groove (groove 50) extending in a lamination direction of the battery cells is provided on the upper surface of the plate-shaped member at a position where the groove overlaps the terminal adjacent portion of the battery cell as viewed from an upper-lower direction.

According to (1), since a gap is formed between the terminal adjacent portion and the plate-shaped member by the groove, even when condensation occurs and condensation water adheres to the battery cell, it is possible to prevent the terminal and the plate-shaped member from being electrically connected to each other to cause a ground fault or a short circuit. Since the occurrence of a ground fault or a short circuit can be prevented by providing the groove in the plate-shaped member, it is not necessary to provide an insulating sheet or the like, and the number of components can be reduced.

(2) The battery module according to (1), in which

a width dimension (width dimension L2) of the groove in a direction orthogonal to the lamination direction is twice or more a depth dimension (depth dimension L1) of the groove.

According to (2), by increasing the width dimension of the groove, it is possible to prevent the condensation water from overflowing from the groove.

(3) The battery module according to (1) or (2), in which

the groove extends to two ends (one end 45a, the other end 45b) of the plate-shaped member in the lamination direction.

According to (3), the condensation water can be discharged from two end sides of the groove.

(4) The battery module according to (1) or (2), in which

one end side of the groove in the lamination direction extends to one end (one end 45a) of the plate-shaped member, and an other end side of the groove in the lamination direction extends to just before an other end (the other end 45b) of the plate-shaped member.

According to (4), the condensation water can be discharged from the one end of the

groove while ensuring rigidity of the plate-shaped member.

(5) The battery module according to (1) or (2), in which

two sides of the groove in the lamination direction extend to just before two ends (one end 45a, the other end 45b) of the plate-shaped member in the lamination direction.

According to (5), the rigidity of the plate-shaped member can be ensured while the groove is provided in the plate-shaped member.

(6) The battery module according to any one of (1) to (5), in which

the upper surface of the plate-shaped member is formed flat except for the groove, and is in contact with a lower surface of the battery cell.

According to (6), since the plate-shaped member comes into contact with the lower surface of the battery cell at a portion excluding the groove, heat dissipation of the battery cell can be promoted.

(7) The battery module according to any one of (1) to (6), further including:

a pair of end plates (end plates 42) provided at two ends of the plurality of battery cells in the lamination direction, in which

the plate-shaped member is connected to the pair of end plates.

According to (7), the plate-shaped member can restrain the battery cells laminated together with the pair of end plates.

(8) A battery pack (battery pack 1) including:

a plurality of laminated battery cells (battery cells 30); and

a battery case (battery case 2) in which the battery cells are placed on an upper surface of a bottom plate (bottom plate 22) and that accommodates the battery cells, in which

each of the battery cells includes a terminal (terminal 37) and a terminal adjacent portion (terminal adjacent portion 36a) that is adjacent to the terminal and is a portion between the terminal and a lower end of the battery cell,

the terminal adjacent portion is a portion where a metal portion (metal portion 362) in the battery cell is exposed, and

a groove (groove 50) extending in a lamination direction of the battery cells is provided on the upper surface of the bottom plate of the battery case at a position where the groove overlaps the terminal adjacent portion of the battery cell as viewed from an upper-lower direction.

According to (8), since a gap is formed between the terminal adjacent portion and the bottom plate of the battery case by the groove, even when condensation occurs and condensation water adheres to the battery cell, it is possible to prevent the terminal and the bottom plate from being electrically connected to each other to cause a ground fault or a short circuit.

What is claimed is:

1. A battery module comprising:
a plurality of laminated battery cells; and
a plate-shaped member having an upper surface on which the battery cells are placed, wherein
each of the battery cells includes a terminal, and a terminal adjacent portion that is adjacent to the terminal and is a portion between the terminal and a lower end of the battery cell,
the terminal adjacent portion is a portion where a metal portion in the battery cell is exposed, and
a groove extending in a lamination direction of the battery cells is provided on the upper surface of the plate-shaped member at a position where the groove overlaps the terminal adjacent portion of the battery cell as viewed from an upper-lower direction.

2. The battery module according to claim 1, wherein
a width dimension of the groove in a direction orthogonal to the lamination direction is twice or more a depth dimension of the groove.

3. The battery module according to claim 1, wherein
the groove extends to two ends of the plate-shaped member in the lamination direction.

4. The battery module according to claim 1, wherein
one end side of the groove in the lamination direction extends to one end of the plate-shaped member, and an other end side of the groove in the lamination direction extends to just before an other end of the plate-shaped member.

5. The battery module according to claim 1, wherein
two sides of the groove in the lamination direction extend to just before two ends of the plate-shaped member in the lamination direction.

6. The battery module according to claim 1, wherein
the upper surface of the plate-shaped member is formed flat except for the groove, and is in contact with a lower surface of the battery cell.

7. The battery module according to claim 1, further comprising:
a pair of end plates provided at two ends of the plurality of battery cells in the lamination direction, wherein
the plate-shaped member is connected to the pair of end plates.

8. A battery pack comprising:
a plurality of laminated battery cells; and
a battery case in which the battery cells are placed on an upper surface of a bottom plate and that accommodates the battery cells, wherein
each of the battery cells includes a terminal and a terminal adjacent portion that is adjacent to the terminal and is a portion between the terminal and a lower end of the battery cell,s
the terminal adjacent portion is a portion where a metal portion in the battery cell is exposed, and
a groove extending in a lamination direction of the battery cells is provided on the upper surface of the bottom plate of the battery case at a position where the groove overlaps the terminal adjacent portion of the battery cell as viewed from an upper-lower direction.
